(19) United States
(12) Patent Application Publication
(10) Pub. No.: US 2007/0038965 A1
(43) Pub. Date: Feb. 15, 2007

(54) Photo printing system and photo printing method

(75) Inventor: Kyeong-Man Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/434,139

(22) Filed: May 16, 2006

(30) Foreign Application Priority Data
Aug. 9, 2005 (KR) 2005-0072973

(51) Int. Cl. G06F 17/50

(52) U.S. Cl. 716/1

(57) ABSTRACT

A photo printing system and a photo printing method are provided. The photo printing system includes a printer for receiving printing data, printing an image on an image portion of a photo printing medium on which an image should be printed, and printing a message on a tear-off portion of the photo printing medium on which no image is printed, and a printing data generating unit for receiving image data for printing the image on the image portion, generating message data for printing the message on the tear-off portion, generating the printing data by combining the image data and the message data, and sending the printing data to the printer. In addition, the photo printing method includes supplying to a printer a photo printing medium having an image portion on which an image is printed and a tear-off portion on which an image is not printed, receiving image data for printing an image on the image portion, generating message data for printing a message on the tear-off portion, sending to the printer printing data generated by combining the image data and the message, and receiving the printing data and printing the image on the image portion and the message on the tear-off portion.

### CROSS-REFERENCE TO RELATED PATENT APPLICATION

This application claims the benefit under 35 U.S.C. §119(a) of a Korean patent application No. 10-2005-0072973, filed on Aug. 9, 2005, in the Korean Intellectual Property Office, the entire disclosure of which is hereby incorporated by reference.

### BACKGROUND OF THE INVENTION

1. Field of the Invention

The present invention relates to a photo printing system. In particular, the present invention relates to a photo system capable of printing a glossy image such as a photo developed on a photo paper and a photo printing method.

2. Description of the Related Art

Printing techniques for printing an image on a printing medium have been developed to the extent that an image taken with a digital camera can be printed as a glossy image like a photo developed on a photo paper. In general, a photo printing medium having a glossy printing surface such as that of a photo paper is required for printing a glossy photo image.

FIG. 1 is a plan view illustrating a photo printed on a conventional photo printing medium. Referring to FIG. 1, the conventional photo printing medium 10 comprises an image portion 11 which is positioned at the center and on which an image is printed and tear-off portions 12 and 13 which is positioned at the upper and lower sides and on which no image is formed. The tear-off portions 12 and 13 for allowing people to readily pick up the photo printing medium 10 serve for preventing the image from being damaged when the image portion 11 is touched by hands in a condition that the image is not completely fixed onto the photo printing medium 10. Each of the tear-off portions 12 and 13 has the width of approximately 10 mm.

Up to now, the tear-off portions 12 and 13 of the photo printing medium 10 have been separated from the image portion 11 and discarded, whereas the image portion 11 on which the image is printed has been preserved in a photo album or the like. Accordingly, there has been a problem of wasting resource. On the other hand, things relating to the photograph printed in the image portion 11 and preserved in the photo album might be forgotten with the lapse of time and thus there were limits in recollecting memories through the photograph.

### SUMMARY OF THE INVENTION

The present invention provides a photo printing system and a photo printing method in which a tear-off portion of a photo printing medium cannot be discarded and can be utilized.

According to an aspect of the present invention, a photo printing system is provided. The system comprises a printer for receiving printing data, printing an image on an image portion of a photo printing medium on which an image should be printed, and printing a message on a tear-off portion of the photo printing medium on which no image is printed, and a printing data generating unit for receiving image data for printing the image on the image portion, generating message data for printing the message on the tear-off portion, generating the printing data by combining the image data and the message data, and sending the printing data to the printer.

The printer may comprise a printer engine for printing the image and the message onto the photo printing medium, and a controller for receiving the printing data from the printing data generating unit and controlling the printing engine to print the image and the message corresponding to the printing data on the photo printing medium.

The printing engine may comprise an ink ribbon on which an ink for coloring the photo printing medium is smeared; and a thermal head for vaporizing the ink smeared on the ink ribbon by applying heat to the ink ribbon and smearing the ink on the photo printing medium.

The printer may comprise an identification sensor for identifying the photo printing medium.

An ID mark for indicating the photo printing medium may be printed in the tear-off portion of the photo printing medium and the identification sensor may serve to identify the photo printing medium by existence of the ID mark.

The identification sensor may comprise a charge coupled device (CCD) camera.

The printing data generating unit may comprise a part which notifies that the message cannot be printed on a printing medium when the printing medium supplied to the printer is not identified as the photo printing medium.

The printing data generating unit may be included in a computer connected to the printer.

The printing data generating unit may be included in the printer.

The printing data generating unit may comprise a part which displays the image corresponding to the received image data on a display screen and which edits the image displayed on the display screen to modify the image data.

The printing data generating unit may comprise a part which generates the message by receiving and editing a message.

The message may comprise at least one of an acquisition date, a location, an event, a photo title, and the like.

The photo printing medium may be a sticker-type printing medium having a printing sheet with the top surface on which the image and the message are printed and the bottom surface which is coated with an adhesive material and a protecting sheet attached to the bottom surface to protect the adhesive material from damage.

According to another aspect of the present invention, a photo printing method is provided. The method comprises supplying to a printer a photo printing medium having an image portion on which an image is printed and a tear-off portion on which an image is not printed, receiving image data for printing an image on the image portion, generating message data for printing a message on the tear-off portion, sending to the printer printing data generated by combining the image data and the message, and receiving the printing data and printing the image on the image portion and the message on the tear-off portion.

The photo printing method may further comprise determining whether a printing medium supplied to the printer is the photo printing medium.

In identifying the photo printing medium, the printing medium supplied to the printer may be recognized as the photo printing medium when an ID mark for indicating a photo printing medium exists in the printing medium.

The photo printing method may further comprise notifying that the message cannot be printed on the printing medium when the printing medium supplied to the printer is not identified as the photo printing medium.

The photo printing method may further comprise displaying the image corresponding to the received image data on a display screen and editing the image displayed on the display screen to modify the image data.

The generating the message data may comprise inputting the message and editing the input message.

The message may comprise at least one of an acquisition date, a location, an event, a photo title, and the like.

### BRIEF DESCRIPTION OF THE DRAWINGS

The above and other features and advantages of the present invention will become more apparent by describing in greater detail exemplary embodiments thereof with reference to the attached drawings in which:

FIG. 1 is a plan view illustrating a photo printed on a conventional photo printing medium;

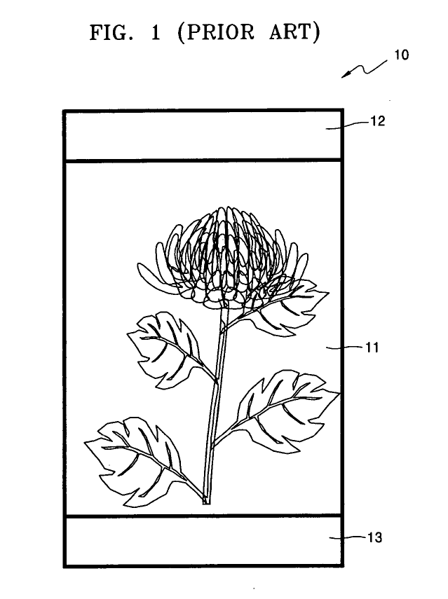

FIG. 2 is a view illustrating a structure of a photo printing system according to an exemplary embodiment of the present invention;

FIG. 3 is a cross-sectional view of a printer of FIG. 2 according to an exemplary embodiment of the present invention;

FIG. 4 is a view illustrating a photo printing medium used in the photo printing system according to an exemplary embodiment of the present invention;

FIG. 5 is a flowchart illustrating the photo printing method by using the photo printing system of FIG. 2 according to an exemplary embodiment of the present invention;

FIG. 6 is a plan view illustrating a photo printed on the photo printing medium of FIG. 4 according to an exemplary embodiment of the present invention;

FIG. 7 is a view illustrating a photo printing medium of FIG. 6 according to an exemplary embodiment of the present invention; and

FIG. 8 is a perspective view illustrating a printer for the photo printing system according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, a photo printing system according to certain exemplary embodiments of the present invention and a photo printing method will be described in detail with reference to the accompanying drawings.

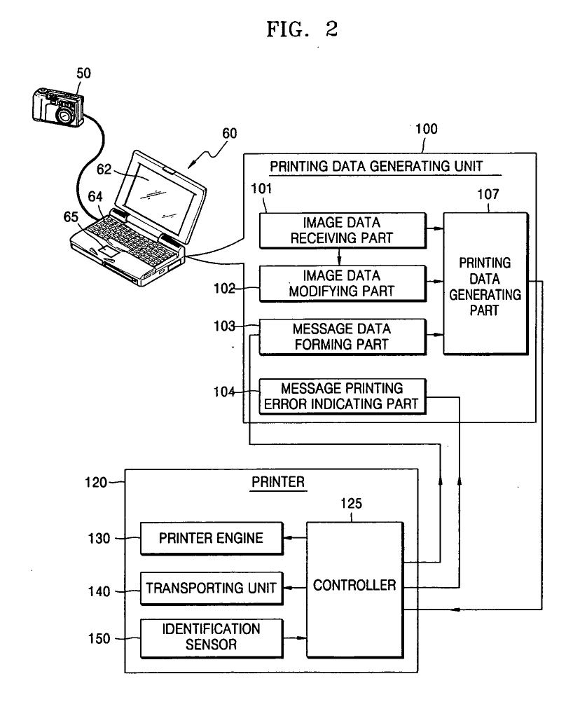

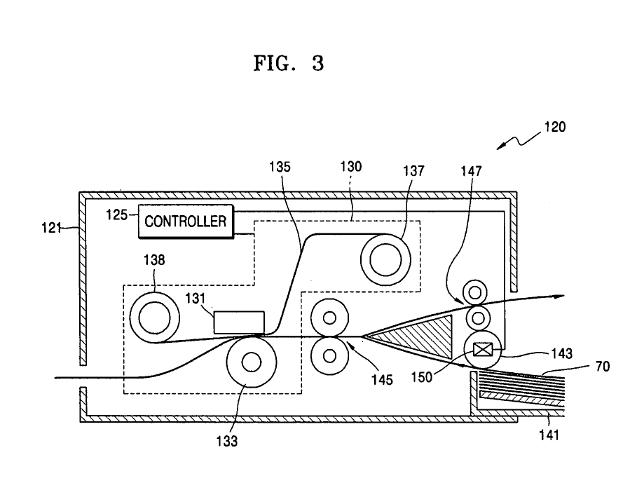

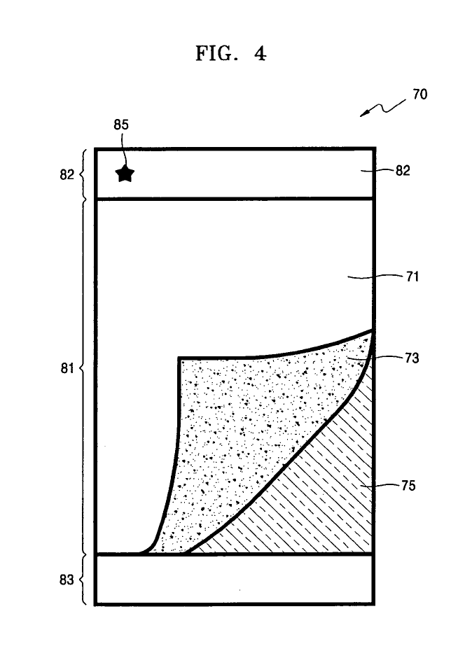

FIG. 2 is a view illustrating a structure of a photo printing system according to an exemplary embodiment of the present invention, FIG. 3 is a cross-sectional view of a printer of FIG. 2 according to an exemplary embodiment of the present invention, and FIG. 4 is a view illustrating a photo printing medium used in the photo printing system according to an exemplary embodiment of the present invention.

Referring to FIG. 4, a photo printing medium 70 used as a printing medium in the photo printing system of the present invention comprises an image portion 81 at the center thereof, on which an acquisition image is printed, and tear-off portions 82 and 83 at the peripheral upper and lower sides thereof on which the image is not printed. The photo printing medium 70, which is so-called a sticker type printing medium that can readily attach a printed photo to a predetermined location, comprises a printing paper 71, on which an image and a message are printed, and a protecting paper 75 for protecting an adhesive material coated at the bottom surface 73 of the printing paper 71 from being damaged. The protecting paper 75 is separated from the printing paper 71, and the printing paper 71 is attached to be displayed at a predetermined location.

An ID mark 85 that is agreed as an indication of a photo printing medium by a printer manufacturer and a printing medium manufacturer is printed on the upper tear-off portion 82. In the photo printing system of an exemplary of the present invention, a printer 120 (see FIG. 2) detects the existence of the ID mark 85 to determine whether or not the provided printing medium is the photo printing medium 70. In the accompanying drawing, a star shape ID mark 85 is depicted, but it is only an exemplary embodiment and various forms of ID marks are possible.

Referring to FIG. 2, the photo printing system comprises a printing data generating unit 100 included in a computer 60 as a form of software or hardware and a printer 120 wherein the computer 60 is connected thereto and a printing data is received from the printing data generating unit 100 to print a photo.

The printing data generating unit 100 comprises an image data receiving part 101 for receiving image data corresponding to an acquisition photo, an image data modifying part 102 for modifying the image data by editing definition, photo size, and brightness while inspecting the image data on a display screen through a display panel 62, and a message data forming part 103 for forming message data corresponding to a message to be printed on the tear-off portions 82 and 83 on the photo printing medium 70. The message may comprise an acquisition date, a location, a relating event (occasion), and a photo title and may comprise one or more among the aforementioned contents. The message can be input by the use of a keyboard 64 of the computer 60, and then the font, color, and background of the input message can be edited by operating the keyboard 64 or a mouse 65.

In addition, the printing data generating unit 100 comprises a printing data generating part 107 for forming printing data by combining the image data and the message data and sending the printing data to a controller 125 in the printer 120, and a message printing error indicating part 104 for informing a user through the display panel 62 of an indication that the message cannot be printed.

Referring to FIGS. 2 and 3, the printer 120 comprises a case of housing 121 forming an enclosure, a printer engine 130 for printing the image and the message on the photo printing medium 70, a transporting unit 140 for providing the photo printing medium 70 to the printer engine 130 in the case 121 and for discharging the photo printing medium 70 of which printing has been complete out of the case 121, and a controller 125 for controlling the printer engine 130 and the transporting unit 140 so that the image and the message can be printed on the photo printing medium 70 by receiving the printing data from the printing data generating unit 100. In addition, an identification sensor 150 for identifying whether or not the provided printing medium is the photo printing medium 70 is provided.

The printer engine 130 comprises an ink ribbon 135, on which an ink for coloring the printing paper 71 of the photo printing medium 70 is smeared, and a thermal head 131 for applying heat on the ink ribbon 135 so that the ink smeared thereon is vaporized to be smeared onto the printing paper 71. A plurality of heating elements (not shown) are arranged at the thermal head 131 in the width direction of the photo printing medium 70, and some of the heating elements selectively generate heat according to a control signal so that the printing paper 71 is colored as mentioned above. The ink ribbon 135 is rolled on a pair of ribbon holder wheels 137 and 138 to be held thereto in order to maintain tension. A platen roller 133 for pressing the photo printing medium 70 and the ink ribbon 135 towards the heating elements (not shown) is provided under the thermal head 131.

The transporting unit 140 comprises a paper loading cassette 141 on which the photo printing medium 70 is loaded, an automatic sheet feed (ASF) roller 143 for picking up the photo printing medium 70 loaded on the paper loading cassette 141 sheet by sheet, a transport roller 145 for feeding the picked up photo printing medium 70 to between the thermal head 131 and the platen roller 133 and which transports the photo printing medium 70 in the opposite direction of feeing the photo printing medium 70 on coloring the photo printing medium 70 and a discharge roller 147 which discharges the photo printing medium 70 of which printing has been complete out of the case 121. The transport roller 145 and the discharge roller 147 comprise a pair of rollers facing each other, and one of them is a driving roller and the other is an idle roller that rotates as the driving roller rotates.

The identification sensor 150 is usually disposed to be on the same line as the ASF roller 143 in the case 121. The identification sensor 150 may comprise a charge coupled device (CCD) camera that visually recognizes the ID mark 85 on the photo printing medium 70. The identification sensor 150 is connected to the controller 125 to send a vision recognition signal.

Hereinafter, a photo printing method according to the photo printing system will be described.

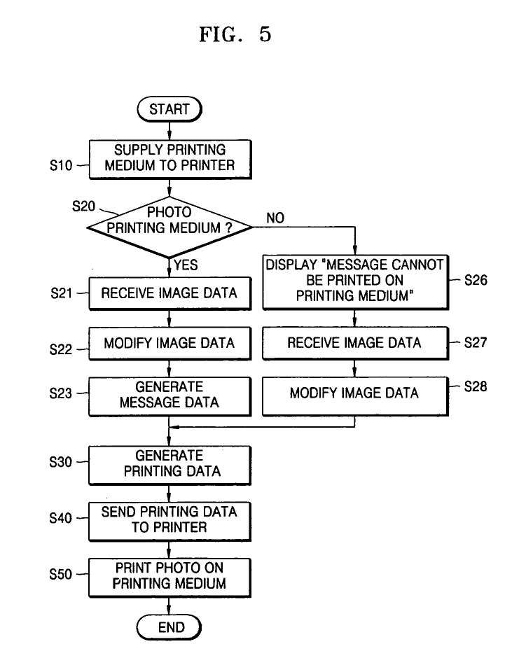

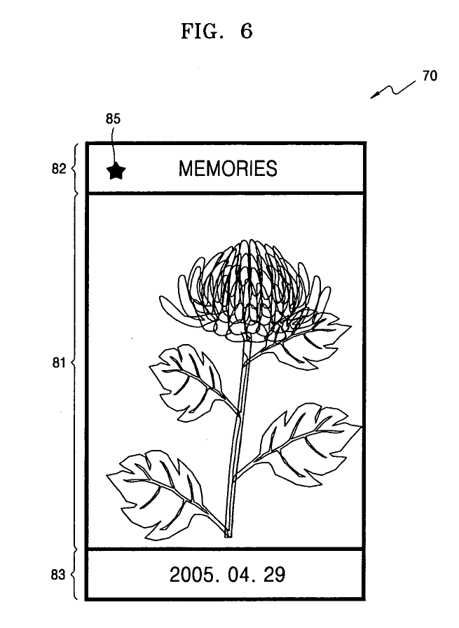

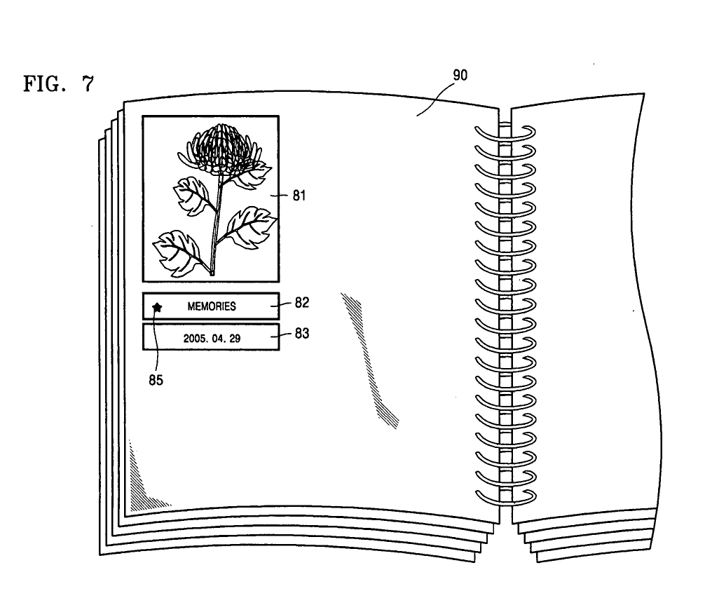

FIG. 5 is a flowchart illustrating the photo printing method using the photo printing system of FIG. 2 according to an exemplary embodiment of the present invention, FIG. 6 is a plan view illustrating a photo printed on the photo printing medium of FIG. 4 according to an exemplary embodiment of the present invention, and FIG. 7 is a view illustrating the photo printing medium of FIG. 6 according to an exemplary embodiment of the present invention.

Referring to FIG. 5, the photo printing medium 70 is first loaded on the paper loading cassette 141 to print a photo, and the paper loading cassette 141 is placed at one side of the case 121 to supply the photo printing medium 70 to the printer 120 in step S10. The photo printing medium 70 must be loaded such that the protecting paper 75 faces downwards and the printing paper 71 faces upwards and such that the upper tear-off portion 82 is positioned under the identification sensor 150 so that the identification sensor 150 can recognizes the ID mark 85.

When the paper loading cassette 141 is placed in the case 121, the identification sensor 150 identifies whether or not the printing medium supplied to the printer 120 is the photo printing medium 70 in step S20. Specifically, the identification sensor 150 visually recognizes the front end portion of the printing medium loaded on the paper loading cassette 141 and sends the vision recognition signal to the controller 125. The controller 125 recognizes the printing medium as the photo printing medium 70 if determined that the ID mark 85, which is marked at the front end portion of the printing medium as an indication of the photo printing medium, exists from the vision recognition signal, and on the contrary, the controller 125 recognizes the printing medium as not the photo printing medium 70 but a general printing medium if determined that the ID mark 85 does not exist on the printing medium from the vision recognition signal.

If the printing medium loaded on the paper loading cassette 141 is recognizes as the photo printing medium 70, the printing data generating unit 100 receives the image data in step S21 to output the image on the display screen through the display panel 62 of the computer 60. The image data is sent from a camera 50 to the computer 60 connected to the camera 50 to be stored in a memory (not shown) in the computer 60, and the printing data generating unit 100 receives the image data from the memory. A user can edit definition, photo size, and brightness of the image output to the display screen to modify the image data by operating the keyboard 64 or the mouse 65 in step S22.

When a blank for a message input comes out on the display screen of the display panel 62, the user inputs and edits a message thereon to form message data in step S23. The blank may come out on the display screen together with the image output or after editing the image output. The message may comprise an acquisition date, a location, a relating event (occasion), and a photo title, and may comprise one or more among the aforementioned contents. The message can be input by the use of the keyboard 64 of the computer 60, and then the font, color, and background of the input message can be edited by operating the keyboard 64 or the mouse 65.

If the printing medium loaded on the paper loading cassette 141 is not recognized as the photo printing medium 70, the printing data generating unit 100 informs the user that the message cannot be printed on the printing medium in step S26. For example, the expression such as “the message cannot be printed on the printing medium” may be shown through the display panel 62. As in the operations S21 and S22, the image data can be received in step S27, and the image data can be modified by the user in step S28. However, the blank for a message input does not come up on the display screen of the display panel 62, and thus message data is not formed.

The printing data generating unit 100 forms printing data by combining image data and message data in step S30 and sends the printing data to the printer 120, specifically, to the controller 125 in the step S40. The controller 125 controls the printer engine 130 and the transporting unit 140, so that the image is printed on the image portion 81 on the photo printing medium 70 and the message is printed on the tear-off portions 82 and 83 thereof as shown in FIG. 6. The photo is printed on the photo printing medium 70 by the aids of the printer engine 130 and the transporting unit 140 at step S50 and the photo printing medium 70 is discharged out of the case 121 of the printer 120.

Photo printing processes of the printer 120 will be explained in detail. The photo printing medium 70 is picked up by the ASF roller 143, and the picked up photo printing medium 70 is fed to between the thermal head 131 and the platen roller 133 separated from each other by the transport roller 145. With the rear end portion of the photo printing medium 70 being stuck in the transport roller 145, the transport roller 145 stops rotating, and the thermal head 131 is closely attached to the platen roller 133, the ink ribbon 135 and the photo printing medium 70 being disposed between the platen roller 133 and the thermal head 131.

The transport roller 145 rotates in the opposite direction with respect to the feeding direction and pulls the photo printing medium 70 disposed between the thermal head 131 and the platen roller 133 to be transported towards the discharge roller 147. The ink ribbon 135 moves at the same transporting speed of the photo printing medium 70, and the heating elements (not shown) in the thermal head 131 selectively generate heat to vaporize the ink smeared on the ink ribbon 135 so that the photo printing medium 70 is colored, and thus an image and a message are formed on the photo printing medium 70. The photo printing medium 70, on which the image and the message are formed, is discharged out of the case 121 by the discharge roller 147.

If the printing medium supplied to the printer 120 is not the photo printing medium 70, the printing data generating unit 100 forms the printing data only with the image data without the message data and sends the printing data to the controller 125 in the printer 120, and thus only acquisition image without any message is printed on the printing medium.

In the photo printing medium 70 discharged out from the printer 120, as shown in FIG. 6, the image is printed on the image portion 81 and the message is printed on the tear-off portions 82 and 83. The printed photo, as shown in FIG. 7, can be arranged in a photo album 90. As mentioned above, the photo printing medium 70 is a sticker type printing medium, so the printing paper 71 on the image portion 81 can be separated from the protecting paper 75 to be attached at one side of the photo album 90, and the printing paper 71 on the tear-off portions 82 and 83 can also be separated from the protecting paper 75 to be attached under the image portion 81. Conveniently, as a result, there is no need for adding a message relative to the photo, such as an acquisition date, a location, a relating event, and a photo title, and the printed message may provide a tidy look.

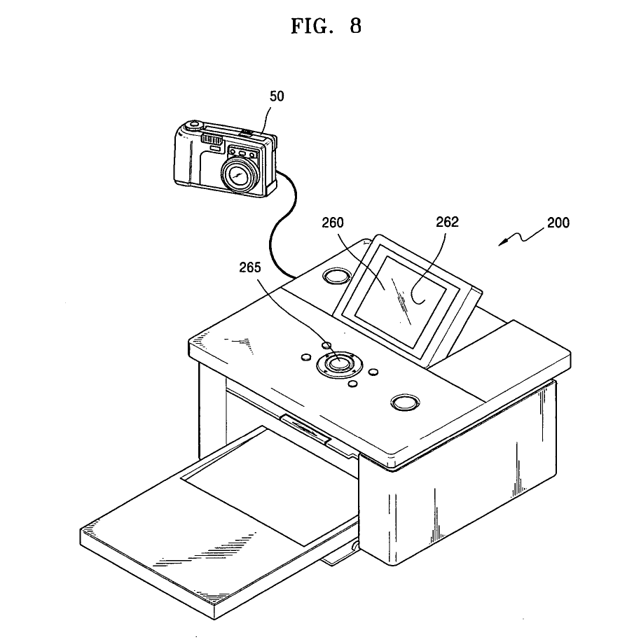

FIG. 8 is a perspective view illustrating a printer for the photo printing system according to an exemplary embodiment of the present invention.

Referring to FIG. 8, in the photo printing system according to an exemplary embodiment of the present invention, a printing data generating unit is included as a form of hardware or software in the printer 200. The printing data generating unit is equivalent to the printing data generating unit 100 according to an exemplary embodiment of the present invention shown in FIG. 2, so detailed descriptions will be omitted. In addition, the structure of the printer 200 is equivalent to the printer 120 according to an exemplary embodiment of the present invention shown in FIGS. 2 and 3 except that the printing data generating unit is included therein, so detailed descriptions will be also omitted.

A printer 200 can be directly connected to a camera 50 to receive image data corresponding to an acquisition image. A user can output the received image data onto a display screen through a display panel 260 and can edit an image through an input key 265 provided to the printer 200 or a touch screen 262 provided to the display panel 260, to modify the image data. In addition, when a blank for a message input comes out on a display screen through the display panel 260, the user can input and edit a message thereon by the use of the input key 265 or the touch screen 262 to form a message data.

A photo printing method by using the photo printing system according to the second embodiment is equivalent as in the description explained with reference to FIG. 5, so detailed descriptions for this will be omitted for clarity and conciseness.

According to a photo printing system and a photo printing method of an exemplary embodiment of the present invention, tear-off portions are not thrown away but usefully used, so waste of resource can be avoided.

In addition, a message relative to a photo can be preserved along with the photo, so memories about the photo can be easily recollected even after long time.

In addition, the message relative to the photo is not handwritten but printed to be preserved along with the photo, providing a tidy look.

While the present invention has been particularly shown and described with reference to exemplary embodiments thereof, it will be understood by those skilled in the art that various changes in form and details may be made therein. For example, the printer included in the photo printing system of the present invention may be an ink jet type printer. Therefore, the spirit and scope of the present invention will be defined by the appended claims. What is claimed is:

1. A photo printing system comprising:
a printer for receiving printing data, printing an image on an image portion of a photo printing medium on which an image should be printed, and printing a message on a tear-off portion of the photo printing medium on which no image is printed; and
a printing data generating unit for receiving image data for printing the image on the image portion, generating message data for printing the message on the tear-off portion, generating the printing data by combining the image data and the message data, and sending the printing data to the printer.

2. The photo printing system according to claim 1, wherein the printer comprises:
a printer engine for printing the image and the message onto the photo printing medium; and
a controller for receiving the printing data from the printing data generating unit and controlling the printing engine to print the image and the message corresponding to the printing data on the photo printing medium.

3. The photo printing system according to claim 2, wherein the printing engine comprises:
an ink ribbon on which an ink for coloring the photo printing medium is smeared; and
a thermal head for vaporizing the ink smeared on the ink ribbon by applying heat to the ink ribbon and smearing the ink on the photo printing medium.

4. The photo printing system according to claim 1, wherein the printer comprises an identification sensor for identifying the photo printing medium.

5. The photo printing system according to claim 4, wherein an ID mark for indicating the photo printing medium is printed in the tear-off portion of the photo printing medium and the identification sensor serves for identifying the photo printing medium by existence of the ID mark.

6. The photo printing system according to claim 5, wherein the identification sensor comprises a charge coupled device (CCD) camera.

7. The photo printing system according to claim 4, wherein the printing data generating unit comprises a notifying part for notifying that the message cannot be printed on a printing medium when the printing medium supplied to the printer is not identified as the photo printing medium.

8. The photo printing system according to claim 1, wherein the printing data generating unit is included in a computer connected to the printer.

9. The photo printing system according to claim 1, wherein the printing data generating unit is included in the printer.

10. The photo printing system according to claim 1, wherein the printing data generating unit comprises a display part for displaying the image corresponding to the received image data on a display screen and editing the image displayed on the display screen to modify the image data.

11. The photo printing system according to claim 1, wherein the printing data generating unit comprises a generating part for generating the message by receiving and editing a message.

12. The photo printing system according to claim 1, wherein the message comprises at least one of an acquisition date, a location, an event, and a photo title.

13. The photo printing system according to claim 1, wherein the photo printing medium is a sticker-type printing medium having a printing sheet with the top surface on which the image and the message are printed and the bottom surface which is coated with an adhesive material and a protecting sheet attached to the bottom surface to protect the adhesive material from damage.

14. A photo printing method comprising:
supplying to a printer a photo printing medium having an image portion on which an image is printed and a tear-off portion on which an image is not printed;
receiving image data for printing an image on the image portion;
generating message data for printing a message on the tear-off portion;
sending to the printer printing data generated by combining the image data and the message; and
receiving the printing data and printing the image on the image portion and the message on the tear-off portion.

15. The photo printing method according to claim 14, further comprising determining whether a printing medium supplied to the printer is the photo printing medium.

16. The photo printing method according to claim 15, wherein the printing medium supplied to the printer is identified as the photo printing medium when an ID mark indicating a photo printing medium exists in the printing medium.

17. The photo printing method according to claim 15, further comprising notifying that the message cannot be printed on the printing medium when the printing medium supplied to the printer is not identified as the photo printing medium.

18. The photo printing method according to claim 14, further comprising displaying the image corresponding to the received image data on a display screen and editing the image displayed on the display screen to modify the image data.

19. The photo printing method according to claim 14, wherein the generating the message data comprises inputting the message and editing the input message.

20. The photo printing method according to claim 14, wherein the message comprises at least one of an acquisition date, a location, an event, and a photo title.
